(19) United States
(12) Patent Application Publication
(10) Pub. No.: US 2025/0334903 A1
(43) Pub. Date: Oct. 30, 2025

(54) IMAGE FORMING APPARATUS

(71) Applicant: CANON KABUSHIKI KAISHA, Tokyo (JP)

(72) Inventors: TAKANORI MITANI, Kanagawa (JP); ISAMU TAKEDA, Tokyo (JP); YUSUKE SHIMIZU, Kanagawa (JP); KOHEI OKAYASU, Shizuoka (JP); MASASHI TANAKA, Kanagawa (JP)

(21) Appl. No.: 19/191,548

(22) Filed: Apr. 28, 2025

(30) Foreign Application Priority Data
Apr. 30, 2024 (JP) 2024-074037

(51) Int. Cl. G03G 15/16; G03G 15/01

(52) U.S. Cl. CPC G03G 15/161; G03G 15/0131; G03G 15/0173; G03G 15/1615

(57) ABSTRACT

An image forming apparatus includes an intermediate member, a plurality of stretching rollers that stretches the intermediate member, a secondary transfer unit performs a secondary transfer, and a cleaning device comes into contact with and separates from the intermediate transfer member and cleans toner remaining on the intermediate transfer member. In a contact nip where the cleaning device and the intermediate transfer member come into contact, the intermediate transfer member is inclined such that an upstream side is lower in a gravity direction than a downstream side. A stretched surface is an outer surface of the intermediate transfer member, and a length in the conveyance direction of the stretched surface upstream of the contact nip is longer than a length in the conveyance direction of a stretched surface of the intermediate transfer member downstream of the contact nip.

### BACKGROUND

### Field of the Disclosure

The present disclosure relates to an image forming apparatus that forms an image on a printing medium.

### Description of the Related Art

Image forming apparatuses that employ an electrophotographic method perform image formation in which toner images formed on respective electrophotographic photosensitive members are primarily transferred and superimposed onto an intermediate transfer member temporarily, and the superimposed toner image on the intermediate transfer member is then secondarily transferred onto a printing medium by a transfer member that comes into contact with the printing medium in order to transfer the image. By using such image forming apparatuses that employ an electrophotographic method, it is possible to obtain a color image with less physical misalignment (color misregistration) of superimposed component color images.

In order to obtain a favorable image, it is important for an image forming apparatus that uses the aforementioned intermediate transfer member to remove (clean) toner remaining on the intermediate transfer member after secondary transfer in which an image is transferred from the intermediate transfer member to a printing medium such as paper. For this reason, Japanese Patent No. 5574924 describes a technique in which a cleaning blade is provided behind a secondary transfer position, and residual toner remaining on an intermediate transfer member is scraped off after the secondary transfer.

However, there have been cases where, when a cleaning device that includes the above cleaning blade comes into contact with the intermediate transfer member, toner ejected from the cleaning portion scatters in the apparatus due to the impact from the contact, causing an image defect.

### SUMMARY

Embodiments of the present disclosure eliminate the above-mentioned issues.

Embodiments of the present disclosure provide a technique for preventing toner ejected due to the impact when a cleaning device comes into contact with an intermediate transfer member from scattering inside an apparatus.

According to embodiments of the present disclosure, there is provided an image forming apparatus comprising: an image carrier that carries a toner image; an intermediate transfer unit that includes: an intermediate member that is a seamless belt; and a plurality of stretching rollers configured to stretch the intermediate member; a secondary transfer unit that includes a secondary transfer roller, and is configured to perform a secondary transfer of a toner image primarily transferred from the image carrier to the intermediate transfer member, from the intermediate transfer member to a printing medium; and a cleaning device configured to come into contact with and separate from the intermediate transfer member in order to clean toner remaining on the intermediate transfer member after the secondary transfer, wherein, in a contact nip where the cleaning device and the intermediate transfer member come into contact with each other, the intermediate transfer member is inclined such that an upstream side in a conveyance direction of the intermediate transfer member is lower in a gravity direction than a downstream side in the conveyance direction of the intermediate transfer member, and wherein a stretched surface is an outer surface of the intermediate transfer member formed between the plurality of stretching rollers when the intermediate transfer member is stretched by the plurality of stretching rollers; and a length in the conveyance direction of the stretched surface of the intermediate transfer member upstream of the contact nip is longer than a length in the conveyance direction of a stretched surface of the intermediate transfer member downstream of the contact nip.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a schematic cross-sectional diagram for describing a schematic cross-sectional configuration of an image forming apparatus according to a first embodiment.

FIGS. 2A and 2B are schematic diagrams showing a schematic configuration of an intermediate transfer belt cleaning device according to the first embodiment.

FIGS. 3A to 3C are schematic diagrams for describing a contact/separated state where the intermediate transfer belt cleaning device is in contact with/separate from the intermediate transfer belt according to the first embodiment.

FIG. 4 is a diagram for describing a configuration for controlling contact/separation of an ICL brush in the image forming apparatus according to the first embodiment.

FIG. 5 is a schematic cross-sectional diagram illustrating a configuration of a general intermediate transfer belt and ICL brush.

FIGS. 6A to 6D are schematic cross-sectional diagrams for describing the positional relation between the intermediate transfer belt and the intermediate transfer belt cleaning device in the image forming apparatus according to the first embodiment, using a modified example and comparison examples.

FIGS. 7A and 7B are schematic diagrams for describing the intermediate transfer belt cleaning device according to a second embodiment.

FIGS. 8A and 8B are diagrams showing evaluation results of the occurrence of uneven image density according to the first and second embodiments.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

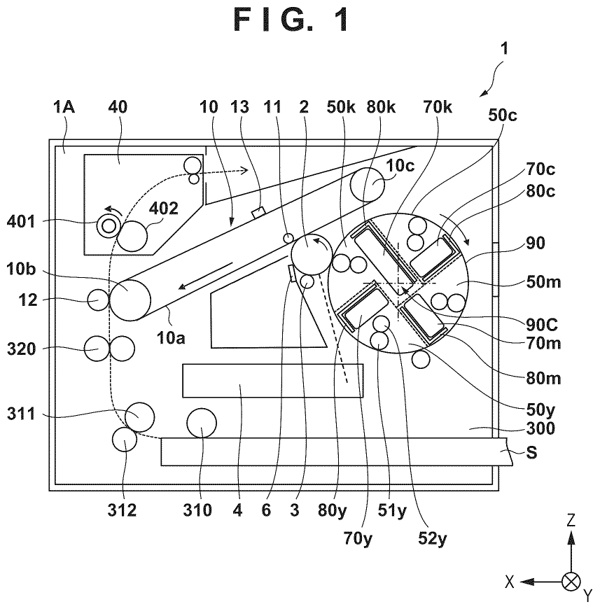

First, an image forming apparatus 1 according to a first embodiment of the present disclosure will be described with reference to FIGS. 1 to 4. In the following description and the drawings, the vertical direction when the image forming apparatus 1 is installed on a horizontal plane is defined as a Z direction. A direction that intersects the Z direction and is the direction of a rotational axis 90C of a later-described rotary body 90 (FIG. 1) (the rotational axis direction of the rotary) is defined as a Y direction. Furthermore, the direction intersecting both the Z direction and the Y direction is defined as an X direction. The X direction and the Y direction are preferably horizontal directions. The X direction, the Y direction, and the Z direction are preferably orthogonal to each other. In addition, as necessary, the directions of the arrows X, Y, and Z illustrated in the drawings are respectively expressed as a +X side, a +Y side, and a +Z side, and the opposite sides to the +X side, the +Y side, and the +Z side are respectively expressed as a −X side, a −Y side, and a −Z side.

FIG. 1 is a schematic cross-sectional diagram for describing a schematic cross-sectional configuration of the image forming apparatus 1 according to the first embodiment.

The image forming apparatus 1 is a laser beam printer that forms an image on a sheet S using an electrophotographic method. More specifically, the image forming apparatus 1 is a color laser beam printer that includes four developing units 50y, 50m, 50c, and 50k. As the sheet S that is a printing material (printing medium), a variety of sheet materials with different sizes and materials can be used, including paper such as plain paper and cardboard, plastic films, fabrics, surface-treated sheet materials such as coated paper, and specially-shaped sheet materials such as envelopes and index paper.

Next, a schematic configuration and an image forming operation of the image forming apparatus 1 will be described with reference to FIG. 1. As shown in FIG. 1, the image forming apparatus 1 includes an image forming apparatus body (hereinafter, an “apparatus body”) 1A and toner cartridges 70y, 70m, 70c, and 70k detachable to the apparatus body 1A. The apparatus body 1A according to the first embodiment is a portion of the image forming apparatus 1 excluding the toner cartridges 70y, 70m, 70c, and 70k.

The apparatus body 1A of the image forming apparatus 1 includes a drum-shaped (cylindrical) electrophotographic photosensitive member (hereinafter, a “photosensitive drum”) 2 as an image carrier that carries an electrostatic latent image. A charging roller 3, a scanner 4 that is an exposure device, and a cleaning unit 6 for the photosensitive drum 2 are disposed near the photosensitive drum 2.

The charging roller 3 is an example of charging means for uniformly charging the photosensitive drum 2. The scanner 4 is an example of exposure means for performing exposure by irradiating the photosensitive drum 2 with laser light that is based on image information. By irradiating the charged photosensitive drum 2 with laser light from the scanner 4, an electrostatic latent image that is based on the image information is formed on the surface of the photosensitive drum 2. The photosensitive drum cleaning unit 6 is an example of cleaning means for removing toner remaining on the surface of the photosensitive drum 2.

In addition, the apparatus body 1A includes the rotary body (a rotary or a rotating member) 90 that includes the developing units 50y, 50m, 50c, and 50k. In the first embodiment, trays 80y, 80m, 80c, and 80k are attached to the rotary body 90. The toner cartridges 70y, 70m, 70c, and 70k are detachably attached to the trays 80y, 80m, 80c, and 80k.

The developing units 50y, 50m, 50c, and 50k are examples of developing means for developing (visualizing) an electrostatic latent image formed on the photosensitive drum 2 into toner images using toner of corresponding colors. The developing units 50y, 50m, 50c, and 50k develop the electrostatic latent image formed on the photosensitive drum 2 using yellow toner, magenta toner, cyan toner, and black toner, respectively.

The developing unit 50y includes a developing roller 51y, a supply roller 52y, and a developing blade (not illustrated). The developing roller 51y is a developing agent carrier that carries toner, which is a developing agent, and rotates to supply yellow toner to the photosensitive drum 2. The supply roller 52y is a supply member that comes into contact with the developing roller 51y, and supplies yellow toner to the developing roller 51. The developing blade is a regulating member that regulates the thickness of a yellow toner layer carried by the developing roller 51y. The other developing units 50m, 50c, and 50k also include the similar developing rollers 51m, 51c, and 51k, supply rollers 52m, 52c, and 52k, and developing blades, respectively.

The toner cartridges 70y, 70m, 70c, and 70k respectively corresponding to the developing units 50y, 50m, 50c, and 50k are mounted to the rotary body 90. The toner cartridges 70y, 70m, 70c, and 70k respectively accommodate yellow toner, magenta toner, cyan toner, and black toner as toner that replenish the developing units 50y, 50m, 50c, and 50k.

The rotary body 90 is rotatable about the rotational axis (rotational center) 90C. In addition, the rotational axis 90C is substantially parallel to the rotational axis (rotational center) of the photosensitive drum 2. The rotary body 90 can assume developing orientation in which one of the developing rollers 51y, 51m, 51c, and 51k faces the photosensitive drum 2 by rotating about the rotational axis 90C. The orientation in which the developing roller 51y faces the photosensitive drum 2 is referred to as yellow developing orientation. The orientation in which the developing roller 51m faces the photosensitive drum 2 is referred to as magenta developing orientation. Also, the orientation in which the developing roller 51c faces the photosensitive drum 2 is referred to as cyan developing orientation. Furthermore, the orientation in which the developing roller 51k faces the photosensitive drum 2 is referred to as black developing orientation. That is to say, the rotary body 90 can rotate about the rotational axis 90C such that the positions of the developing rollers 51y, 51m, 51c, and 51k relative to the photosensitive drum 2 change.

The apparatus body 1A includes motors M1 (not illustrated), M2 (not illustrated), and M3 as driving sources. The motor M1 supplies drive power for rotating the rotary body 90 about the rotational axis 90C. In addition, the motor M2 moves the trays 80y, 80m, 80c, and 80k relative to the rotary body 90.

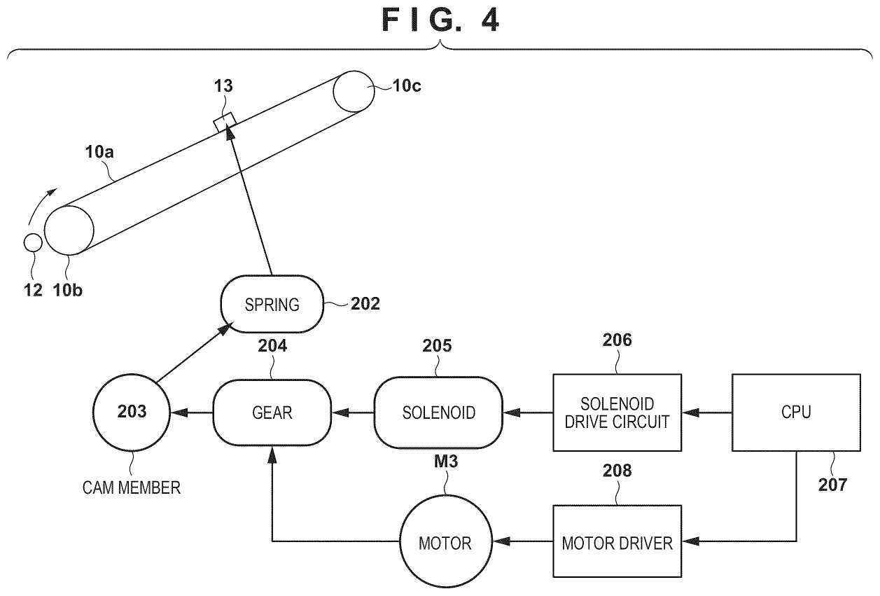

The motor M3 (FIG. 4) drives members other than members that are driven by the motor M1 and the motor M2. The motor M3 drives the photosensitive drum 2, the developing units 50y, 50m, 50c, and 50k, a pickup roller 310, a feed roller 311, a conveyance roller pair 320, a secondary transfer roller 12, a belt drive roller 10b, and a fixing unit 40, for example. Furthermore, the motor M3 is used for driving a contact/separation operation of the secondary transfer roller 12 and an intermediate transfer belt cleaning device (cleaning portion) 13 relative to an intermediate transfer belt 10a. Note that the motor M3 may include a plurality of motors, and members that are driven by the motors M1, M2, and M3 can be changed as appropriate. In addition, it is also possible to integrate the functions of any two or all of the three motors M1, M2, and M3 into one motor. On the other hand, a driving source different from the motors M1, M2, and M3 may be added.

Here, the subscripts “y”, “m”, “c”, and “k” of the reference signs for the developing units 50y, 50m, 50c, and 50k, the toner cartridges 70y, 70m, 70c, and 70k, the trays 80y, 80m, 80c, and 80k, and the like respectively indicate the colors of toner of the corresponding units, members, and the like. Here, the subscripts “y”, “m”, “c”, and “k” respectively indicate yellow, magenta, cyan, and black. Basic configurations and functions of the developing units 50y, 50m, 50c, and 50k are the same. Basic configurations and functions of the toner cartridges 70y, 70m, 70c, and 70k are also the same. Basic configurations and functions of the trays 80y, 80m, 80c, and 80k are also the same. Therefore, when there is no need to distinguish between colors, description will be given in which reference numeral without the subscript “y”, “m”, “c”, or “k” indicates any one of the four units, any one of the four cartridges, or any one of the four trays.

The apparatus body 1A also includes a sheet stack 300, the pickup roller 310, the feed roller 311, a separation roller 312, the conveyance roller pair 320, the secondary transfer roller 12, the fixing unit 40, and an intermediate transfer unit 10. The pickup roller 310 is an example of feeding means for feeding sheets S. The feed roller 311 and the separation roller 312 are an example of a separation-and-conveyance unit that conveys sheets S while separating the sheets S one sheet at a time due to frictional force. The secondary transfer roller 12 is an example of transfer means for transferring an image from the intermediate transfer belt 10a to the sheet S.

The intermediate transfer unit 10 includes the intermediate transfer belt 10a, the belt drive roller 10b, a tension roller 10c, the (intermediate transfer belt) cleaning device 13, and a primary transfer roller 11. The intermediate transfer belt 10a is a seamless belt, and is an example of an intermediate transfer member that carries an image (primarily) transferred from the photosensitive drum 2, and conveys the image in order to (secondarily) transfer the image onto the sheet S. The intermediate transfer belt 10a is stretched over the belt drive roller 10b and the tension roller 10c. The belt drive roller 10b is a driving member that conveys the intermediate transfer belt 10a by being rotated and driven by the motor M3 that is a driving source.

In the fixing unit 40, the sheet S is heated and pressurized, and an image is fixed to the sheet S. The fixing unit 40 includes a pressing roller (pressing body) 401 and a fixing film (fixing rotary body) 402. The pressing roller 401 and the fixing film 402 are pressed against each other, thus forming a fixing nip portion. In addition, a heater member, which is a heat source, is disposed on the inner side of the fixing film 402, and, as a result of the heater member heating the fixing film 402, a toner image on the sheet S passing the fixing nip portion is heated and pressurized, thereby being fixed.

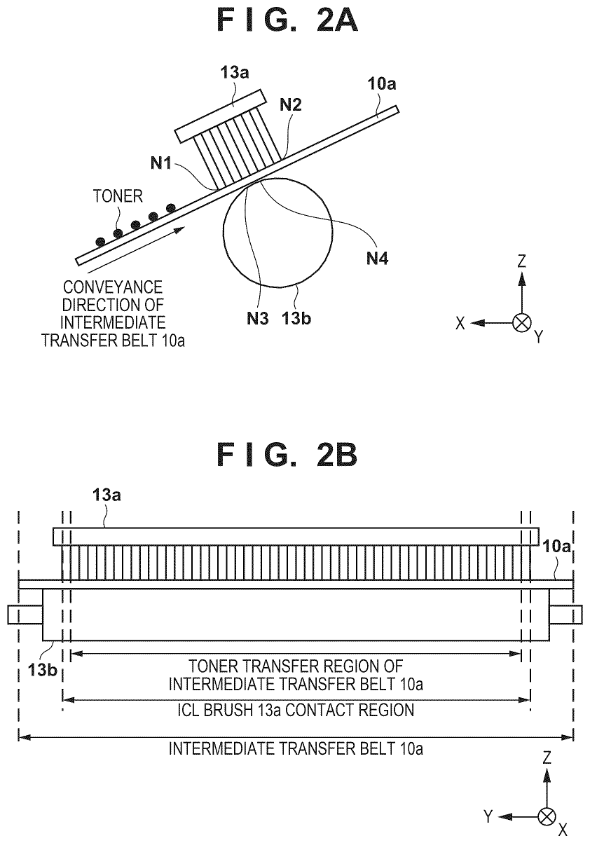

FIGS. 2A and 2B are schematic diagrams showing a schematic configuration of the cleaning device 13 for the intermediate transfer belt 10a according to the first embodiment.

FIG. 2A shows a cross-sectional configuration diagram of the intermediate transfer belt cleaning device 13 in a contact state as viewed from the Y axis direction. The intermediate transfer belt cleaning device 13 includes an ICL brush 13a on the outer peripheral surface side of the intermediate transfer belt 10a and an ICL facing member (backup member) 13b on the inner peripheral surface side, sandwiching the intermediate transfer belt 10a. The ICL brush 13a and the intermediate transfer belt 10a form a nip portion (N1-N2), and the ICL facing member 13b and the intermediate transfer belt 10a form a nip portion (N3-N4). In the first embodiment, the nip portion (N1-N2) includes regions (N1-N3) and (N4-N2) where the ICL facing member 13b is not present (regions that are not backed up by the ICL facing member 13b), but the present disclosure is not limited to such a configuration. The intermediate transfer belt 10a in the regions where the ICL facing member 13b is not present minutely transforms when the ICL brush 13a comes into contact with the intermediate transfer belt 10a, and thereby the impact when the ICL brush 13a comes into contact with the intermediate transfer belt 10a is reduced. Thus, by adopting such a configuration, it is possible to reduce the scattering distance of toner held on the ICL brush 13a. Note that the ICL facing member 13b is not essential.

The ICL brush 13a includes a support body and brush bristles, and has a function for charging residual toner to the polarity opposite to the charging potential of the photosensitive drum 2, and a function for entangling and temporarily holding a part of the residual toner on the brush. Thus, the brush bristles of the ICL brush 13a according to the first embodiment are made of a conductive resin such as nylon or rayon, and are woven onto the support body with a predetermined bristle density. Specifically, brush bristles made of a conductive nylon resin and having a length of 5 mm and a single fiber fineness of 5 dtex are woven onto a support body at a density of 100 kF/inch². The ICL facing member 13b is a cylindrical aluminum roller member, and rotates following the conveyance of the intermediate transfer belt 10a.

FIG. 2B is a longitudinal schematic diagram of the intermediate transfer belt cleaning device 13 as viewed from the X axis direction.

The length in the axial direction (the Y axis direction) of the ICL brush 13a is set such that a region in which toner is transferred onto the surface of the intermediate transfer belt 10a can be covered. Specifically, the length in the Y axis direction of the intermediate transfer belt 10a is 236 mm, the length in the Y axis direction of the ICL brush 13a is 224 mm, and the length in the Y axis direction of a toner transfer region is 220 mm. In addition, the ICL brush 13a can come into contact with and separate from the intermediate transfer belt 10a.

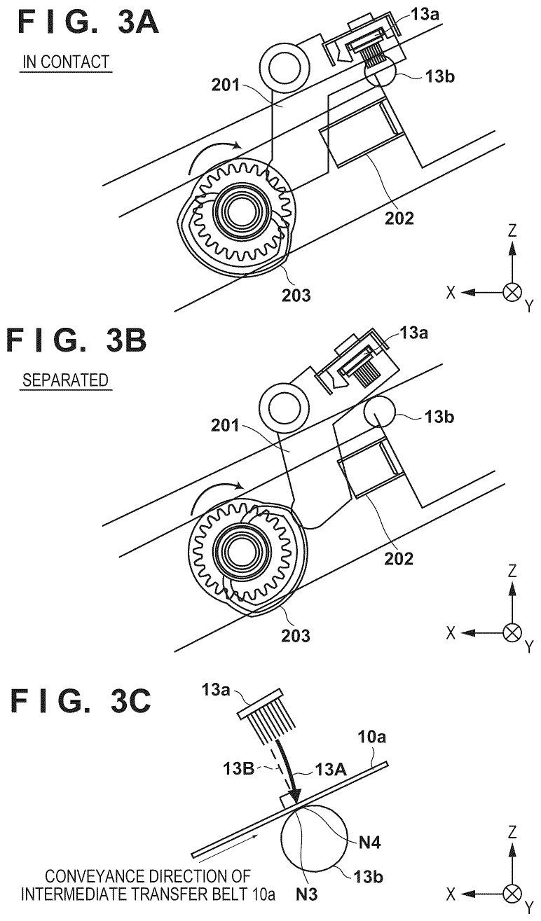

FIGS. 3A to 3C are schematic diagrams for describing a contact/separated state where the intermediate transfer belt cleaning device 13 is in contact with/separate from the intermediate transfer belt 10a according to the first embodiment.

FIG. 3A is a schematic cross-sectional diagram of a state where the ICL brush 13a is in contact with the intermediate transfer belt 10a, and FIG. 3B is a schematic cross-sectional diagram of a state where the ICL brush 13a is separate from the intermediate transfer belt 10a. The ICL brush 13a is held on a lever 201, and the lever 201 is revolvable about the Y direction that is used as a rotation axis. A spring 202 is disposed at an end portion of the lever 201 on the opposite side to a holding portion of the lever 201 where the ICL brush 13a is held, and presses the lever 201 in the direction in which the ICL brush 13a comes into contact with the intermediate transfer belt 10a. By the ICL brush 13a being supported due to the pressure applied by this spring 202, the ICL brush 13a can be stably brought into contact with the intermediate transfer belt 10a. In addition, by adjusting the pressure of contact of the ICL brush 13a with the intermediate transfer belt 10a using the spring 202, deformation of the brush bristles of the ICL brush 13a due to the contact can be suppressed.

In addition, as shown in FIG. 3B, by a cam member 203, which is a switching member, rotating in the arrow direction (clockwise), the lever 201 is pressed along with the spring 202, and the ICL brush 13a is moved to a position separate from the intermediate transfer belt 10a.

FIG. 3C is a cross-sectional configuration diagram of the intermediate transfer belt cleaning device 13 in a state where the ICL brush 13a and the intermediate transfer belt 10a are separate from each other as viewed from the Y axis direction. The arrow 13A indicates a path on which a central position of the nip portion (N1-N2) of the ICL brush 13a moves when the ICL brush 13a transitions from a separated state to a contact state. The broken line 13B indicates a perpendicular line to the surface of the intermediate transfer belt 10a, at the central portion of the nip portion (N1-N2) of the ICL brush 13a in the contact state. The arrow 13A immediately before the contact state is positioned downstream of the broken line 13B in the conveyance direction of the intermediate transfer belt 10a. This makes it more likely for scattered toner when the ICL brush 13a comes into contact with the intermediate transfer belt 10a to scatter toward the upstream side in the conveyance direction. This is because, when the ICL brush 13a collides with the intermediate transfer belt 10a and slows down, toner held on the ICL brush 13a is likely to scatter in the direction of the arrow 13A, that is, toward the upstream side in the conveyance direction of the intermediate transfer belt 10a, due to inertial force.

FIG. 4 is a diagram for describing a configuration for controlling contact/separation of the ICL brush 13a in the image forming apparatus 1 according to the first embodiment.

The cam member 203 is coupled to a driving source by a gear train. A claw is released due to a solenoid 205 performing a suction operation for a certain period, and a final-stage gear 204 that transmits a drive force to the cam member 203 then rotates by 360 degrees by being driven by the motor M3, which is a driving source. In the first embodiment, a configuration is adopted in which, when the final-stage gear 204 rotates by 360 degrees, the cam member 203 rotates by 120 degrees. Therefore, the contact/separated state of the ICL brush 13a transitions by being driven by the solenoid 205, and the solenoid 205 is driven by a signal output by a CPU 207, which is the control unit, via a solenoid drive circuit 206. The CPU 207 also drives the motor M3 via a motor driver 208.

In addition, the intermediate transfer belt cleaning device 13 is disposed downstream of a secondary transfer nip (contact portion where the intermediate transfer belt cleaning device 13 is in contact with the secondary transfer roller 12) in the conveyance direction of the intermediate transfer belt 10a. In the first embodiment, the intermediate transfer belt cleaning device 13 is disposed downstream of the central position between the belt drive roller 10b and the tension roller 10c.

Next, an image forming operation according to the first embodiment will be described. First, the photosensitive drum 2 is rotated in the arrow direction (counterclockwise) in FIG. 1 in synchronization with rotation of the intermediate transfer belt 10a. The surface of the photosensitive drum 2 is then uniformly charged by the charging roller 3.

When forming a color image on the sheet S, the rotary body 90 rotates in the arrow direction (clockwise) in FIG. 1 while supporting the developing units 50y, 50m, 50c, and 50k. An electrophotographic process is then repeatedly performed while moving the developing rollers 51y, 51m, 51c, and 51k to a development position one at a time.

First, the scanner 4 irradiates the photosensitive drum 2 with laser light that is based on image data corresponding to a yellow image, and forms an electrostatic latent image corresponding to the yellow image on the surface of the photosensitive drum 2. In parallel with formation of this electrostatic latent image, the motor M1 rotates the rotary body 90, and the rotary body 90 assumes the yellow developing orientation. When the rotary body 90 assumes the yellow developing orientation, the developing roller 51y is at the development position, and develops the electrostatic latent image formed on the photosensitive drum 2 using yellow toner. A developing voltage of the polarity opposite to the charging potential of the photosensitive drum 2 is applied to the developing roller 51y such that toner adheres to the latent image on the photosensitive drum 2.

In the first embodiment, the developing rollers 51y, 51m, 51c, and 51k are elastic rollers with rubber coating around metal shafts. At the development position, the developing rollers 51y, 51m, 51c, and 51k each develop the electrostatic latent image in a state of being in contact with the photosensitive drum 2. That is to say, the image forming apparatus 1 according to the first embodiment adopts a contact development method. However, at the development position, the developing rollers 51y, 51m, 51c, and 51k may each develop the electrostatic latent image with a gap between the photosensitive drum 2 and the developing roller 51y, 51m, 51c, or 51k. That is to say, the image forming apparatus 1 may adopt a non-contact development method.

When a yellow toner image is developed, the yellow toner image on the photosensitive drum 2 is primarily transferred onto the intermediate transfer belt 10a by the primary transfer roller 11 disposed on the inner side of the intermediate transfer belt 10a. At this time, a primary transfer voltage of the polarity opposite to the toner image formed on the photosensitive drum 2 is applied to the primary transfer roller 11.

From this point on, by rotating the rotary body 90 and moving the developing rollers 51m, 51c, and 51k to the development position in order, toner images of the respective colors are sequentially formed on the photosensitive drum 2. Specifically, after a yellow toner image is transformed on the intermediate transfer belt 10a, the rotary body 90 assumes the magenta developing orientation, and a magenta toner image is superimposed and transformed on the yellow toner image on the intermediate transfer belt 10a. After the magenta toner image is transformed on the intermediate transfer belt 10a, the rotary body 90 assumes the cyan developing orientation, and a cyan toner image is superimposed and transformed on the toner image of yellow and magenta on the intermediate transfer belt 10a. After the cyan toner image is transformed on the intermediate transfer belt 10a, the rotary body 90 assumes the black developing orientation, and a black toner image is started to be formed on the intermediate transfer belt 10a. During a period until a YMC toner image of yellow, magenta, and cyan formed on the intermediate transfer belt 10a passes the secondary transfer portion and the cleaning device, the secondary transfer roller 12 and the cleaning device 13 are in a separated state of not being in contact with the intermediate transfer belt 10a. The secondary transfer roller 12 comes into contact with the intermediate transfer belt 10a during a period from when the YMC toner image formed on the intermediate transfer belt 10a passed the secondary transfer portion until when the leading edge of a YMCK color toner image on the intermediate transfer belt 10a, on which the toner image of the fourth color, namely black is formed, reaches the secondary transfer portion again.

On the other hand, sheets S are fed from the sheet stack 300 provided on the lower side of the apparatus body 1A, by the pickup roller 310. The sheet Sis sent to the conveyance roller pair 320 in a state of being separated as individual sheets by the feed roller 311 and the separation roller 312. The sheets S sent to the conveyance roller pair 320 waits until the YMCK toner image is formed on the above intermediate transfer belt 10a. After the toner image is formed on the intermediate transfer belt 10a, the sheet S, which has been held in standby at the conveyance roller pair 320, is conveyed, and is sent to the transfer portion (secondary transfer portion) that is the nip portion between the intermediate transfer belt 10a and the secondary transfer roller 12. In this manner, the color image on the intermediate transfer belt 10a is (secondarily) transferred onto the surface of the conveyed sheet S. At this time, a secondary transfer voltage of the polarity opposite to the charging potential of the toner image is applied to the secondary transfer roller 12.

In this manner, the sheet S onto which the color image has been transferred is sent to the fixing unit 40. The sheet S is heated and pressurized in the fixing unit 40, and the image is fixed to the sheet S. The sheet S that has passed the fixing unit 40 is discharged as a product to the outside of the image forming apparatus 1.

Residual toner remaining on the surface of the intermediate transfer belt 10a after the secondary transfer is cleaned by the intermediate transfer belt cleaning device 13 as follows.

The ICL brush 13a has a function for charging residual toner on the intermediate transfer belt 10a to the polarity opposite to the charging potential of the photosensitive drum 2, and a function for temporarily holding a part of residual toner by entangling the portion of the residual toner on the brush. The residual toner on the intermediate transfer belt 10a is charged to the polarity opposite to the charging potential of the photosensitive drum 2 by passing the ICL brush 13a. Since the photosensitive drum 2 in the first embodiment is negatively charged and a positive voltage is applied to the ICL brush 13a, residual toner that has passed the ICL brush 13a is positively charged. The residual toner positively charged in this manner moves to the negatively charged surface of the photosensitive drum 2 at the primary transfer nip, and is collected by the cleaning unit 6 for the photosensitive drum 2. Note that the toner image supported on the photosensitive drum 2 at the primary transfer nip may be primarily transferred to intermediate transfer belt 10a at the same time as residual toner moves to the surface of the photosensitive drum 2 negatively charged at the primary transfer nip.

On the other hand, residual toner temporarily held on the ICL brush 13a without passing the ICL brush 13a is discharged from the ICL brush 13a onto the intermediate transfer belt 10a again in an operation after image formation. At the primary transfer nip, the residual toner then moves to the surface of the photosensitive drum 2, and is collected by the photosensitive drum cleaning unit 6. Note that all of the toner temporarily held on the ICL brush 13a is not discharged to the intermediate transfer belt 10a, and a certain amount of residual toner after secondary transfer is still held on the ICL brush 13a.

It is conceivable that, in a state where toner is held on the ICL brush 13a, the ICL brush 13a transitions from a state of being separate from the intermediate transfer belt 10a to a state of being in contact. In such a case, due to the shock at the time of the contact, the toner held on the ICL brush 13a is ejected to the outside of the ICL brush 13a. If this ejected toner scatters inside the apparatus, moves inside the apparatus due to gravity and airflow inside the apparatus, and adheres to a member other than the intermediate transfer belt 10a, there is a risk that a problem such as an image defect will occur. There is a risk that a problem called backside contamination will occur in which scattered toner that has adhered to the surface of the secondary transfer roller 12 adheres to and stains the back side of the sheet S, for example. There is also a risk that a problem called uneven image density will occur due to scattered toner adhered to the scanner 4 blocking a part of laser light in the Y axis direction, thereby decreasing the image density at the corresponding position and causing streak-like density unevenness.

Next, a mechanism in which toner discharged from an ICL brush scatters inside an apparatus when a cleaning device comes into contact with an intermediate transfer belt will be described using a general example.

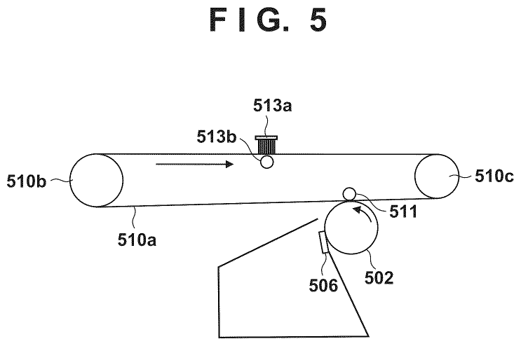

FIG. 5 is a schematic cross-sectional diagram illustrating a configuration of a general intermediate transfer belt 510a and ICL brush 513a.

In FIG. 5, the intermediate transfer belt 510a includes an ICL facing member (backup member) 513b on the inner peripheral surface side and the intermediate transfer belt 510a at the position of contact with the ICL brush 513a is horizontal. When the ICL brush 513a comes into contact with the intermediate transfer belt 510a in this state, scattered toner ejected from the ICL brush 513a scatters to both the upstream side and downstream side in the conveyance direction of the intermediate transfer belt 510a.

If the toner that has scattered to the downstream side (the right side in FIG. 5) out of the above toner moves to a curved surface of the intermediate transfer belt 510a formed by the intermediate transfer belt 510a wrapping around a tension roller 510c due to conveyance thereof, a part of the toner may scatter inside the apparatus. The reason why scattered toner on the curved surface portion of the intermediate transfer belt 510a scatters inside the apparatus is that the polarity of the scattered toner cannot be controlled. In addition, the curved surface portion of the intermediate transfer belt 510a is subject to minute expansion and contraction due to tension and curvature fluctuations of the intermediate transfer belt 510a, and it is not easy to hold scattered toner on the intermediate transfer belt 510a.

On the other hand, the toner that has scattered to the upstream side (left side in FIG. 5) is unlikely to scatter inside the apparatus. The toner that has scattered to the upstream side reaches the ICL brush 513a again through conveyance of the intermediate transfer belt 510a, is charged by the ICL brush 513a, and passes the ICL brush 513a, or is held on the ICL brush 513a again. The scattered toner that has been charged and passed the ICL brush 513a in this manner remains on the intermediate transfer belt 510a without scattering within the apparatus due to electrostatic adhesion force, even on the curved surface portion of the intermediate transfer belt 510a, moves to the surface of a photosensitive drum 502, and is collected by a cleaning unit 506.

In view of this, in the first embodiment, in order to suppress scattering of toner within the apparatus, the intermediate transfer belt 10a at the position of contact with the intermediate transfer belt cleaning device 13 is inclined such that the upstream side in the conveyance direction of the intermediate transfer belt 10a matches the downward side in the gravity direction.

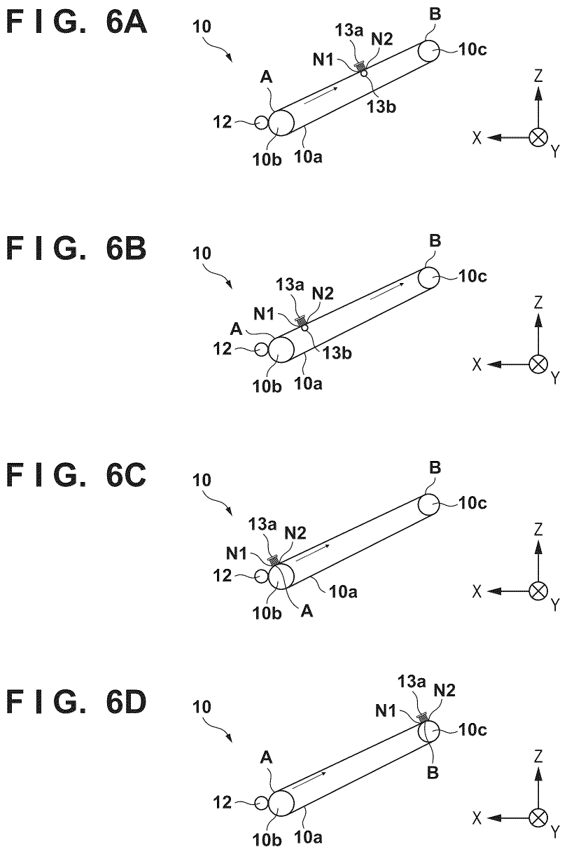

FIGS. 6A to 6D are schematic cross-sectional diagrams for describing the positional relation between the intermediate transfer belt 10a and the intermediate transfer belt cleaning device 13 in the image forming apparatus 1 according to the first embodiment, using a modified example and comparison examples.

FIG. 6A is a schematic cross-sectional diagram illustrating the positional relation between the intermediate transfer belt 10a and the intermediate transfer belt cleaning device 13 according to the first embodiment.

The intermediate transfer belt 10a at the contact nip (N1-N2) position faces upward in the gravity direction, and is inclined such that the upstream side in the conveyance direction matches the downward side in the gravity direction. In addition, stretched surfaces (A-N1) and (N2-B) facing upward in the gravity direction are respectively provided on the upstream side and downstream relative to the contact nip (N1-N2) position. The stretched surfaces are outer surfaces of the intermediate transfer member formed between plurality of stretching rollers when the intermediate transfer member is stretched by the plurality of stretching rollers. The plurality of stretching rollers are the belt drive roller 10b and the tension roller 10c. The inclination of these stretching faces (A-N1) and (N2-B) relative to the horizontal plane is set to an angle smaller than or equal to the rest angle of toner. Specifically, the rest angle of toner according to the first embodiment is 45°, and the upstream side of the intermediate transfer belt 10a corresponding to the contact nip (N1-N2) position, the stretching face (A-N1), and the stretching face (N2-B) is inclined downward in the gravity direction by 27°. A method for measuring the rest angle will be described later. In addition, the relation in length between the stretching face (A-N1) and the stretching face (N2-B) satisfies (A-N1)> (N2-B).

In the present embodiment, the rest angle of toner was obtained by the following method.
Measurement apparatus: powder tester PT-N(Hosokawa Micron Corporation)
Measurement method conforms to rest angle measurement in the user manual accompanying powder tester PT-N(sieve opening: 710 μm, vibration time: 180 s, amplitude: 2 mm or smaller).

Note that, after leaving a sample at 23° C. and 60% RH overnight, a rest angle was measured using the measurement apparatus in an environment of 23° C. and 60% RH, and measurement was repeated five times to obtain an average value, which is set as the rest angle.

Next, an effect of suppressing toner scattering inside the apparatus at the moment when the ICL brush 13a according to the first embodiment comes into contact with ICL will be described.

As described above, the intermediate transfer belt 10a at the contact nip (N1-N2) position is inclined. For this reason, when the ICL brush 13a minutely vibrates due to shock at the time of contact and the toner held on the ICL brush 13a is ejected, toner is likely to scatter downward in the gravity direction due to gravity. In this manner, in the first embodiment, by decreasing the amount of toner that scatters to the downstream side (upward direction in FIG. 6A) where toner is likely to scatter inside the apparatus, and increasing the amount of toner that scatters to the upstream side (downward direction in FIG. 6A) where toner is unlikely to scatter inside the apparatus, the amount of toner that scatters inside the apparatus is suppressed.

In addition, in the first embodiment, by setting the angle of the stretching face (A-N1) to an angle smaller than or equal to the rest angle of toner, scattered toner is more effectively kept from scattering inside the apparatus. With this configuration, the toner that has scattered to the upstream side (downward direction in FIG. 6A) is easily conveyed to the position of the ICL brush 13a again without rolling down the stretching face (A-N1) and scattering inside the apparatus.

In addition, as the contact nip (N1-N2) position may be any position as long as stretching faces facing upward in the gravity direction are respectively positioned upstream and downstream thereof. For example, the distance of the stretching face (A-N1) may be shorter than the distance of the stretching face (N2-B) as in the modified example shown in FIG. 6B. Note that, as in FIG. 6A in the first embodiment, the ICL brush 13a is more preferably disposed such that the distance of the stretching face (A-N1) is longer than the distance of the stretching face (N2-B).

Compared with a case where the intermediate transfer belt 10a is not inclined, the scattering distance of toner scattering to the upstream side in the conveyance direction at the time of contact is long while the scattering distance of toner scattering to the downstream side in the conveyance direction is small, due to the inclination of the intermediate transfer belt 10a at the contact nip (N1-N2) position. Here, if the distance of the stretching face (A-N1) is shorter than the scattering distance of scattered toner, toner that has scattered to the upstream side in the conveyance direction may scatter inside the apparatus without being conveyed to the ICL brush 13a again. Therefore, the distance of the stretching face (A-N1) is set to be longer than the distance of the stretching face (N2-B).

On the other hand, if no stretching face facing upward in the gravity direction is present upstream or downstream of the position of the contact nip (N1-N2), a larger amount of toner scatters inside the apparatus. For example, as in comparison example 1 shown in FIG. 6C, in a configuration where the ICL brush 13a is disposed on the intermediate transfer belt 10a and faces the belt drive roller 10b, toner that has scattered to the upstream side scatters to a curved surface of the intermediate transfer belt 10a.

In addition, as in comparison example 2 shown in FIG. 6D, in a configuration in which the ICL brush 13a is disposed on the intermediate transfer belt 10a and faces the tension roller 10c, scattered toner that has scattered to the downstream side scatters onto a curved surface of the intermediate transfer belt 10a. Such toner that has scattered to the curved surface portion of the intermediate transfer belt 10a is unstable, and thus is likely to scatter inside the apparatus after rolling down the curved surface portion. Therefore, the arrangements of the ICL brush 13a such as those shown in FIGS. 6C and 6D are not favorable.

Next, as for the first embodiment, an image evaluation test after a sheet passing durability operation was conducted.

As configurations of an image forming apparatus for an evaluation test, two types of configurations, namely the configuration according to the first embodiment and a configuration of a conventional example were prepared.

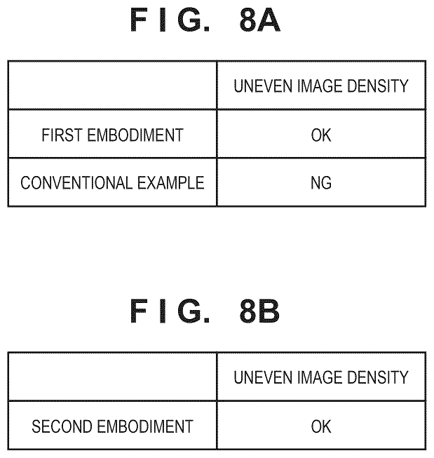

An image estimation method was performed in an N/N environment (temperature: 23° C., humidity: 50%) by an image forming apparatus printing an estimation image on evaluation paper, the image forming apparatus having processed 50,000 sheets of paper. Specifically, after performing single-sided printing of an image having an 8% print coverage (image of horizontal lines of each of yellow toner, magenta toner, cyan toner, and black toner with a 2% print coverage) on 50,000 sheets of letter-sized plain paper (grammage: 75 g/m²), single-sided printing of a full-page halftone image with 50% print coverage of black toner was performed as an estimation image. A result of estimation on uneven image density is “OK” if the uneven image density of the halftone image of the estimation image cannot be visually confirmed, or “NG” if it can be visually confirmed. FIG. 8A shows evaluation results.

According to the above evaluation test, it can be seen that a problem caused by toner that has scattered inside the apparatus can be suppressed according to the first embodiment.

The first embodiment has been described using color printing image formation as an example, but similar actions and effects are also achieved in monochrome printing image formation, which is not excluded from the disclosure.

In addition, a configuration in which the ICL brush is separated from the intermediate transfer belt also has an effect of improving the durability of the intermediate transfer belt, and the ICL brush and the intermediate transfer belt are preferably in a separated state wherever possible. Thus, also in monochrome printing, there is an issue of unintended scattering of toner to the intermediate transfer belt due to contact/separation of the ICL brush, and in the configuration of the present disclosure, similar actions and effects are achieved.

Note that, in the first embodiment, an image forming apparatus that performs multi-stage development using a single photosensitive drum has been described as an example, but similar actions and effects are also achieved using an image forming apparatus that uses a so-called in-line method and performs image forming using photosensitive drums of the respective colors arranged on an intermediate transfer belt, which is not excluded from the scope of the disclosure.

Note that, in the first embodiment, a cleaning method that uses the ICL brush 13a as the intermediate transfer belt cleaning device 13 is adopted, but the present disclosure is not limited to such a configuration. For example, a cleaning method that uses a roller-shaped charging member in place of the ICL brush 13a may also be used. In addition, a method for collecting toner on the intermediate transfer belt 10a and storing the toner in a separately provided waste toner box may also be used. In the case of this method, as a member for collecting toner on the intermediate transfer belt 10a, a plate-shaped resin or metal member, a brush-shaped resin or metal member, or the like is used. The present disclosure also has a similar effect of keeping toner held on such a member for collecting toner from scattering inside the apparatus. Note that a cleaning method that uses a charging member adopts a configuration in which toner is intentionally held on the intermediate transfer belt cleaning device 13, and thus, a larger amount of toner tends to scatter compared with the aforementioned method for collecting toner and storing the toner in a separately provided waste toner box. Thus, in a cleaning method that uses a charging member, the configuration of the first embodiment is more effective.

In addition, if a member that comes into contact with the intermediate transfer belt 10a as the intermediate transfer belt cleaning device 13 is a brush rather than a plate or a roller, the surface area of the member is larger and a larger amount of toner is stored, and thus a larger amount of toner tends to scatter. Thus, in a configuration in which the ICL brush 13a is used, among configurations for cleaning methods that use a charging member, the configuration of the first embodiment is more effective.

As described above, according to the first embodiment, toner ejected from a cleaning device due to the impact when the cleaning device comes into contact with an intermediate transfer belt can be ejected in a larger amount to the upstream side in the conveyance direction of intermediate transfer belt. Accordingly, after the cleaning device comes into contact with the intermediate transfer belt, it is possible to collect toner ejected onto the intermediate transfer belt, and thus the first embodiment has an effect of suppressing an image defect that occurs due to toner scattering inside the apparatus.

### Second Embodiment

Next, a second embodiment of the present disclosure will be described. The second embodiment has the same configuration as the first embodiment above except that a portion of the intermediate transfer belt 10a is stretched over and wraps around the ICL facing member 13b.

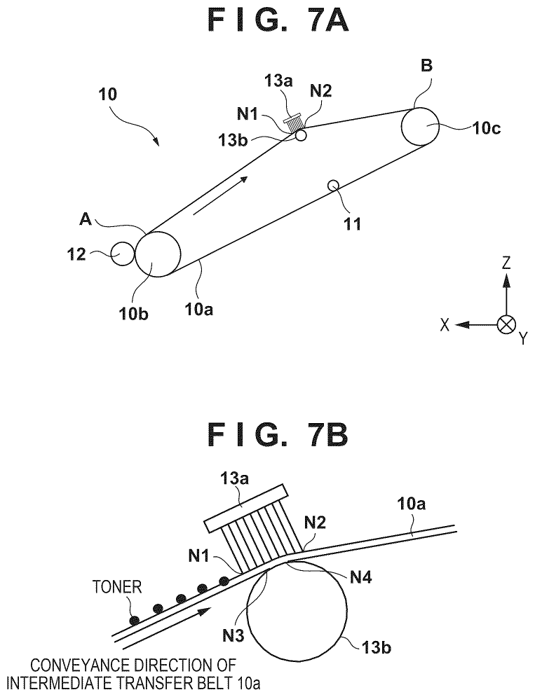

FIGS. 7A and 7B are schematic diagrams for describing an intermediate transfer belt cleaning device according to the second embodiment.

FIG. 7A is a schematic diagram for describing a contact state where the intermediate transfer belt cleaning device 13 is in contact with the intermediate transfer belt 10a according to the second embodiment. FIG. 7B is an enlarged view of a contact portion between the ICL brush 13a and the intermediate transfer belt 10a in FIG. 7A.

As shown in FIGS. 7A and 7B, the ICL facing member (backup member) 13b is disposed at a position further upward in the gravity direction than in the configuration of the first embodiment in FIG. 6A. Accordingly, the intermediate transfer belt 10a is stretched over not only the belt drive roller 10b and the tension roller 10c but also the ICL facing member 13b. With this configuration, the nip portion (N3-N4) between the ICL facing member 13b and the intermediate transfer belt 10a can be formed to be larger, and the conveyance of the intermediate transfer belt 10a can be stabilized.

Also in the second embodiment, the intermediate transfer belt 10a at the contact nip (N1-N2) position is inclined such that the upstream side in the conveyance direction matches the downward side in the gravity direction. The stretching faces (A-N1) and (N2-B) facing upward in the gravity direction are respectively provided upstream and downstream of the contact nip (N1-N2) position. In addition, the inclination of the stretching face (A-N1) is smaller than or equal to the rest angle of toner, and, specifically, inclination of the stretching face (A-N1) is 34°. On the other hand, the inclination of the stretching face (N2-B) is 10°.

In this manner, also in the second embodiment, a test for confirming the same effects as the first embodiment was conducted, and thus FIG. 8B shows the results.

As shown in FIG. 8B, also in the second embodiment, it can be seen that a problem caused by toner that has scattered inside the apparatus can be suppressed.

Note that, in the second embodiment, the nip portion (N1-N2) includes the regions (N1-N3) and (N4-N2) where the ICL facing member 13b is not present, but the present disclosure is not limited to such a configuration. A configuration may also be adopted in which, for example, the nip portion (N1-N2) is included in the region of the nip portion (N3-N4).

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-074037, which was filed on Apr. 30, 2024 and which is hereby incorporated by reference herein in its entirety.

What is claimed is:

1. An image forming apparatus comprising:
an image carrier that carries a toner image;
an intermediate transfer unit that includes:
an intermediate transfer member that is a seamless belt; and
a plurality of stretching rollers configured to stretch the intermediate transfer member;
a secondary transfer unit including a secondary transfer roller and configured to perform a secondary transfer of a toner image, primarily transferred from the image carrier to the intermediate transfer member, from the intermediate transfer member to a printing medium; and
a cleaning device configured to come into contact with and separate from the intermediate transfer member, and configured to clean toner remaining on the intermediate transfer member after the secondary transfer,
wherein, in a contact nip where the cleaning device and the intermediate transfer member come into contact with each other, the intermediate transfer member is inclined such that an upstream side in a conveyance direction of the intermediate transfer member is lower in a gravity direction than a downstream side in the conveyance direction of the intermediate transfer member, and
wherein a stretched surface is an outer surface of the intermediate transfer member formed between the plurality of stretching rollers when the intermediate transfer member is stretched by the plurality of stretching rollers; and
a length in the conveyance direction of the stretched surface of the intermediate transfer member upstream of the contact nip is longer than a length in the conveyance direction of a stretched surface of the intermediate transfer member downstream of the contact nip.

2. The image forming apparatus according to claim 1, wherein an inclination of the stretched surface of the intermediate transfer member upstream of the contact nip is smaller than or equal to a rest angle.

3. The image forming apparatus according to claim 1, wherein the plurality of stretching rollers includes a first roller that is close to the secondary transfer roller and a second roller that is more distant from the secondary transfer roller than the first roller, and wherein a position in the gravity direction of the first roller is lower than the second roller.

4. The image forming apparatus according to claim 1, further comprising:
a backup member that backs up the intermediate transfer member from a surface of the intermediate transfer member opposite to a surface that comes into contact with the cleaning device,
wherein the backup member does not back up the intermediate transfer member at edge portions on the upstream side and the downstream side of the contact nip.

5. The image forming apparatus according to claim 4, wherein the intermediate transfer member is stretched over the backup member in addition to the first roller that is close to the secondary transfer roller and the second roller that is more distant from the secondary transfer roller than the first roller.

6. The image forming apparatus according to claim 5, wherein a distance between the first roller and the backup member is longer than a distance between the second roller and the backup member.

7. The image forming apparatus according to claim 1, wherein a path on which the cleaning device moves immediately before the cleaning device comes into contact with the intermediate transfer member is positioned on the downstream side of the intermediate transfer member in the conveyance direction relative to a perpendicular line to a surface of the intermediate transfer member at a central portion of the contact nip.

8. The image forming apparatus according to claim 1, wherein a voltage of a polarity opposite to a regular polarity of toner is applied to the cleaning device, and the cleaning device charges a portion of toner remaining on the intermediate transfer member to the opposite polarity and holds the portion of the toner.

9. The image forming apparatus according to claim 1, wherein the cleaning device includes a brush member and is configured to bring the brush member into contact with the intermediate transfer member.
